(19) United States
(12) Patent Application Publication
(10) Pub. No.: US 2005/0002655 A1
(43) Pub. Date: Jan. 6, 2005

(54) Image transcription apparatus and data transfer method used for the same

(76) Inventors: Hideto Noguchi, Hitachinaka (JP); Hiroshi Shimizu, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/909,395

(22) Filed: Aug. 3, 2004

Related U.S. Application Data
(63) Continuation of application No. 09/748,174, filed on Dec. 27, 2000.

(30) Foreign Application Priority Data
Dec. 28, 1999 (JP) 11-372670

(51) Int. Cl. B41B 1/00

(52) U.S. Cl. 386/126; 386/49

(57) ABSTRACT

An image transcription apparatus inludes a random access recording medium which has a picture data recording area, an attribute data recording area and a thumbnail image data recording area for storing image data indicating features of the picture date in correspondence to the attribute data. A memory is employed which has a work area used upon recording of the picture data on the recording medium and reproduction therefrom, an attribute data storage are for storing the attribute data recorded on the recording medium and a shared storage area used for storing temporarily the picture data upon recording and reproduction. The shared storage area is so arranged as to be capable of storing the thumbnail image data when the picture data is neither being recorded nor reproduced. The attribute data and the thumbnail image data can speedily be displayed on the display unit.

### BACKGROUND OF THE INVENTION

1. Field of the Invention

The present invention relates generally to an image transcription apparatus (which may also be referred to as the picture recording/reproducing apparatus) for transcribing or recording image or picture data on a recording medium which can be accessed at random (hereinafter also referred to as the random access recording medium only for the convenience of description). The present invention is further concerned with a data transfer method of transferring information or data corresponding or relevant to the picture data recorded on the random access recording medium.

2. Description of the Related Art

In recent years, the image transcription apparatus or picture recording apparatus which incorporates a random access recording medium such a memory typified by a so-called disk memory, a semiconductor memory or the like has been developed for practical applications and used increasingly, replacing the conventional image transcription apparatus in which the video tape is employed as the recording medium. Most of the image transcription apparatuses of this sort is ordinarily imparted with the function of displaying the contents of transcribed or recorded pictures in the form of a list of thumbnail images by taking advantage of the fact that the recording medium as employed allows random access thereto.

For displaying a thumbnail image, the content of a relevant picture as transcribed or recorded may be decoded so as to be capable of outputting the corresponding thumbnail image for display every time the transcription or recording operation has been performed. However, in case the picture data as transcribed are recorded dispersely on a random access recording medium, not a little access time is involved for reaching a location where the picture data of concern is recorded, which means that the display of the thumbnail image is accompanied with a delay correspondingly. Such being the circumstances, man frequently resorts to such measures as generating in advance the thumbnail image data for saving it on the random access recording medium in addition to recording of the ordinary picture data upon every image transcription or picture recording. Since such thumbnail image is ordinarily of a small data amount or size, it can be outputted for display at a high speed.

Further, the image transcription apparatus of the type described above is ordinarily so designed as to be capable of recording on the random access recording medium such attribute information or data as typified by picture recording date/time, title and the like in correspondence to the individual picture data, respectively, in addition to the thumbnail image data for each of the picture data. Obviously, the amount of these thumbnail image data and attribute data increases as the transcription or picture recording is repeatedly performed. Consequently, there may arise such situation in which become necessary to delete the transcribed or recorded picture data most be deleted. In that case, the corresponding or relevant thumbnail image data and attribute data will also have to be deleted from the allocated storage area on the random access recording medium.

On the other hand, it is also noted that most of the image transcription apparatuses of the type described above are equipped with a buffer memory of a large capacity with a view to realizing a stable recording of the picture data generated successively on the random access recording medium whose recording speed is not constant and/or for the purpose of making available a series of successive picture data required for smooth reproduction thereof from the random access recording medium whose reproduction speed is also inconstant.

By virtue of the arrangement that the thumbnail image data are previously stored in the storage area allocated thereto on the random access recording medium, it is certainly possible to display the thumbnail image data at a speed increased to some extent. In that case, the thumbnail image data to be displayed is read out from the storage area on the random access recording medium and directly displayed on a monitor.

As a literature containing description concerning the selection of picture data transcribed or recorded on a random access recording medium as well as a menu for the selection, there can be mentioned Japanese Laid-Open Patent Application Publication No. (11-331739).

### SUMMARY OF THE INVENTION

In the light of the state of the art described above, it is an object of the present invention to provide an image transcription apparatus (or a picture recording apparatus) which is capable of outputting for display the thumbnail image data and the attribute data at a high speed without incurring increase of expenditure and mounting space.

Another object of the present invention is to provide a data transfer method for transferring the thumbnail image data and the attribute data, which method can be adopted advantageously and effectively in the image transcription apparatus mentioned above.

In view of the above and other objects which will become apparent as the description proceeds, it is proposed according to a general aspect of the present invention that by taking advantage of the fact that a buffer memory area of a memory usually incorporated in the image transcription apparatus in which a random access recording medium (i.e., recording medium allowing random access thereto) is employed is used only when reproduction or transcription (picture recording operation) is being carried out, the buffer memory area is made use of for holding or storing the thumbnail image data read out from the random access recording medium in the case where neither reproduction nor recording of picture is performed but the thumbnail image data are being displayed, for example, in the form of a list.

By virtue of the arrangement described above, expenditure which would otherwise be involved for mounting additionally a memory to be dedicated only for holding or storing the thumbnail image data of pictures and additionally the attribute data thereof, as the case may be, can be spared, making it nevertheless possible to output for display the thumbnail image data and the attribute data, if required, at a high speed while suppressing manufacturing cost of the image transcription apparatus and the package size thereof from increasing.

In a preferred mode for carrying out the present invention, the thumbnail image data and the attribute data of picture data are recorded in a single storage area secured on the random access recording medium. In that case, it is also preferred to adopt such measures that the thumbnail image data and the corresponding attribute data are not recorded alternately with each other but the thumbnail image data and the attribute data are continuously recorded discretely or separately from each other in the single storage area on the random access recording medium, i.e., the thumbnail image data are recorded continuously or successively in a subarea of the single storage area with the attribute data being recorded also continuously in another subarea of the single storage area.

With the arrangement described above, it is possible that even in such reproduction mode that thumbnail image data are not required to be displayed but only the attribute data have to be outputted continuously or successively for display, the attribute data can be made available swiftly. Furthermore, in the case where only the thumbnail image data are to be transferred to the buffer memory area from the random access recording medium, futile access such as “skip” which may occur in case the thumbnail image data and the attribute data have been recorded alternately can be suppressed to a possible minimum.

In another preferred mode for carrying out the invention, the area (subarea of the single storage area on the recording medium) for recording the attribute data should previously be secured in a fixed size on the recording medium so that the size of the attribute data area need not be increased or decreased in dependence on the number of the picture data as picked up and hence the number of the thumbnail image data.

The arrangement mentioned above is advantageous in that in the case where a part of the attribute data is deleted, such a troublesome processing as repositioning the attribute data closely to one another within the attribute data area can be lessened to a possible minimum.

In yet another mode for carrying out the present invention, it is preferred to adopt such arrangement that when the state in which the thumbnail image data written in the buffer memory area is being displayed on the monitor is changed over to the state for enabling the picture reproducing or recording operation, the thumbnail image data being currently displayed is copied onto a thumbnail-image-dedicated area secured separately or independently from the buffer memory area. In that case, when the same thumbnail image data is to be displayed again, the thumbnail-image-dedicated area can be checked in precedence to the transfer of the same thumbnail image data from the recording medium to the buffer memory area so that the thumbnail image data can be transferred to the monitor for display from the thumbnail-image-dedicated area when the thumbnail image data is found in that area.

The arrangement described above is advantageous in that displaying of the thumbnail images can be accomplished at a high speed even when the thumbnail image display mode and the reproduction or transcription (recording) mode are frequently changed over.

In still another mode for carrying out the invention, it is preferred to secure in advance the storage area for recording the thumbnail image data and the attribute data on the recording medium before the image transcription is initially performed. To this end, there may be secured on the random access recording medium firstly a plurality of the attribute data areas, thence a plurality of the thumbnail image data areas and thence a plurality of the picture data recording areas in this order as viewed in the direction from the innermost periphery of the recording medium toward the outer periphery thereof.

The arrangement mentioned above is effective for preventing fragmentation of the storage area on the random access recording medium, which in turn is effective for preventing the access time from increasing due to such fragmentation, to thereby allow the thumbnail images to be displayed speedily and swiftly. The technique described above may be applied to an optical disk storage medium and magneto-optical disk storage medium.

The above and other objects, features and attendant advantages of the present invention will more easily be understood by reading the following description of the preferred embodiments thereof taken, only by way of example, in conjunction with the accompanying drawings.

### BRIEF DESCRIPTION OF THE DRAWINGS

In the course of the description which follows, reference is made to the drawings, in which:

FIG. 1 is a block diagram showing schematically and generally a system configuration of an image transcription apparatus (e.g., a video camera system) according to an exemplary embodiment of the present invention;

FIG. 2 is a schematic view for illustrating conceptually a random access recording medium employed in the image transcription apparatus shown in FIG. 1 and having a picture data recording area and an attribute data/thumbnail image data recording area secured thereon;

FIG. 3 is a view for illustrating in what manner a memory incorporated in the image transcription apparatus shown in FIG. 1 is used;

FIG. 4 is a view for illustrating in detail a structure of the attribute data/thumbnail image data area secured on the random access recording medium shown in FIG. 2;

FIG. 5 is a view for illustrating, by way of example, an array of thumbnail image data records, attribute data records and picture data records; and

FIG. 6 is a view for illustrating another example of the array of thumbnail image data records, attribute data records and picture data records.

### DETAILED DESCRIPTION OF THE INVENTION

The present invention will now be described in detail in conjunction with what is presently considered as preferred or typical embodiments thereof by reference to the drawings. In the following description, like reference characters designate like or corresponding parts throughout the several views.

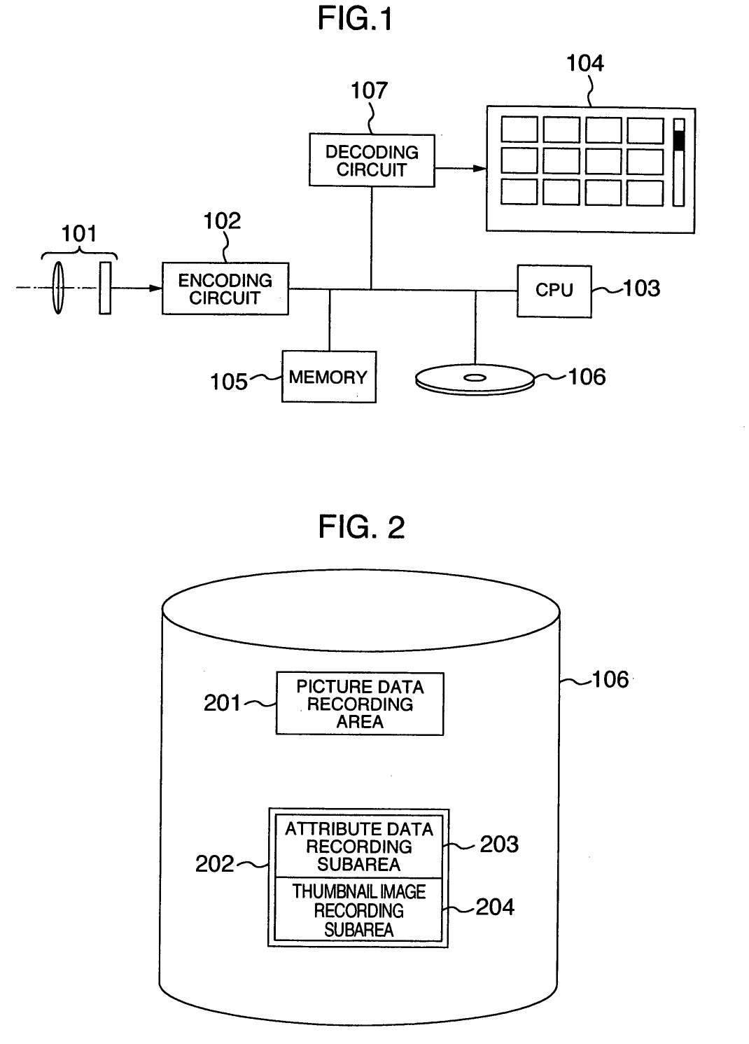

FIG. 1 is a block diagram showing schematically and generally a configuration of the image transcription apparatus according to an embodiment of the present invention on the presumption that the invention is applied to a video camera system, a typical one of the image transcription apparatuses. Referring to the figure, in an image transcribing operation (picture recording operation) mode, a digital picture signal (video signal) outputted from a camera unit 101 undergoes an encode processing such as compression in an encoding circuit 102 to be subsequently stored as picture data once in a memory 105 under the control of a CPU (Central Processing Unit) 103. The encoded picture data stored in the memory 105 are intermittently transferred onto a random access recording medium (i.e., recording medium allowing random access thereto) 106 from the memory 105 under the control of the CPU 103. This CPU 103 also serves for the function of generating the thumbnail image data and the attribute data of the recorded picture data, as will hereinafter be described. The thumbnail image data and the attribute data are recorded in a storage area 202 (FIG. 2) secured on the recording medium 106.

In the reproduction mode, the picture data are intermittently outputted from the random access recording medium 106 to be stored once in the memory 105 and then outputted therefrom continuously to be supplied to a decoding circuit 107 again under the control of the CPU 103. The picture data inputted to the decoding circuit 107 are decoded to be subsequently outputted to a monitor 104. The CPU 103 additionally serves for the function of displaying the thumbnail image data of the picture data recorded on the random access recording medium 106 in the form of a list of thumbnail images on the monitor 104. In that case, an area of the memory 105 is used as a work area for outputting the thumbnail image data.

In the state illustrated in FIG. 1, there is displayed on the screen of the monitor 104 a thumbnail screen image which includes twelve thumbnail image frames arrayed in 12 fields of 3 rows×4 columns, respectively. In this conjunction, it goes without saying that the present invention is never restricted to such thumbnail image display in twelve frames but a given number of thumbnail images can be displayed in a given frame array.

FIG. 2 is a schematic view for illustrating conceptually a recording area allocation on the random access recording medium 106 employed in the data transcription apparatus shown in FIG. 1. Referring to FIG. 2, there are prepared on the recording medium 106 a picture data recording area 201 and additionally one storage area 202 independently from the picture data recording area 201. The storage area 202 is comprised of a thumbnail image data recording subarea 204 dedicated for recording the thumbnail image data of the picture data and an attribute data recording subarea 203 dedicated for recording the attribute data such as dates, titles or the like of the picture data in correspondence to the thumbnail image data, respectively.

In the picture data recording area 201 of the recording medium 106, a plurality of picture data are recorded whereas recorded in the subareas 203 and 204 of the storage area 202 are a plurality of attribute data of the picture data and a corresponding number of thumbnail image data thereof, respectively.

When a picture data is additionally recorded in the picture data recording area 201, the thumbnail image data and the attribute data corresponding to the recorded picture data are also recorded additionally in the subarea 204 and 203, respectively, of the storage area 202.

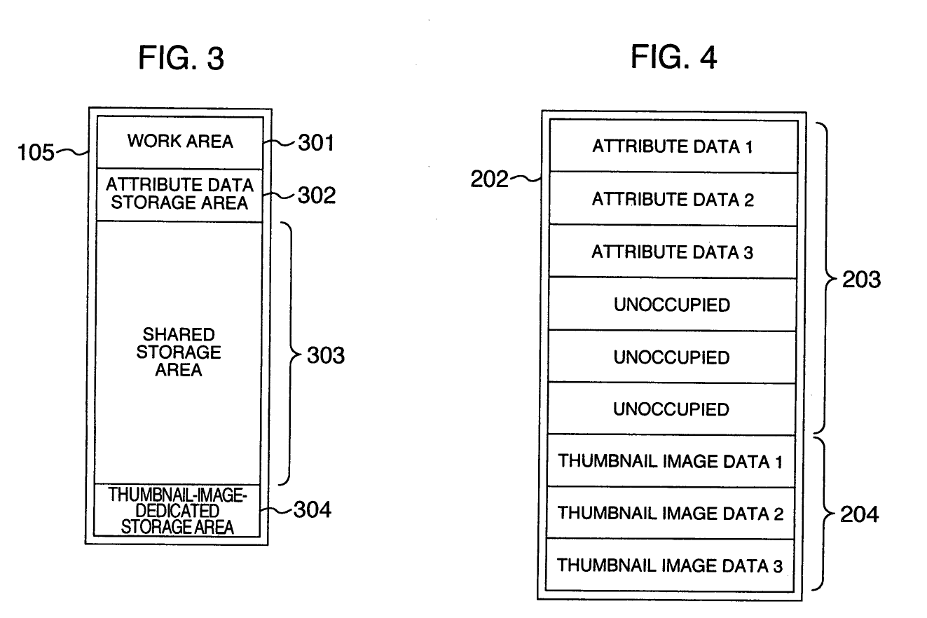

Next, description will be made of a method of controlling operations of the data transcription apparatus with the aid of the CPU 103. FIG. 3 is a view for illustrating in what manner the memory 105 incorporated in the image transcription apparatus shown in FIG. 1 is used. As can be seen in FIG. 3, the memory 105 is logically partitioned or divided into four areas. They are a work area 301, an attribute data storage area 302, a shared storage area 303 and a thumbnail-image-dedicated storage area 304.

The work area 301 is used by the CPU 103 shown in FIG. 1 for controlling operations of the image transcription apparatus on the whole. The attribute data storage area 302 is loaded with the attribute information or data from the attribute data recording subarea 203 shown in FIG. 2 upon activation of the apparatus. The shared storage area 303 is used as a buffer for storing temporarily the picture data in the state where the picture recording operation (image transcribing operation) or reproducing operation is carried out. The thumbnail image data can be outputted for display in the state when neither picture recording nor reproducing operation is performed. Thus, in this state, the thumbnail image data stored in the subarea 204 shown in FIG. 2 can be written in the shared storage area 303 shown in FIG. 3 because the shared storage area is not used either for picture recording or for picture reproduction.

By storing the thumbnail image data in the shared storage area 303 of the memory 105 for displaying the thumbnail images on the monitor 104, the time taken for outputting the thumbnail image data for display from the recording medium 106 or for outputting again the thumbnail image data once displayed can significantly be shortened. In other words, the thumbnail image data can be displayed at a high speed. Furthermore, by virtue of such arrangement that the shared storage area 303 of the memory 105 utilized as the buffer memory for the picture recording and reproduction can also be used for storing the thumbnail image data in a sharing manner, there arises no necessity of securing or providing another memory for the purpose of displaying the thumbnail image data, which contributes to miniaturization and inexpensive implementation of the apparatus.

In this conjunction, it is however noted that even in the case where the state transition occurs frequently between the thumbnail image data output/ display state and the picture recording/reproducing state, the thumbnail image data has to be written in the shared storage area 303 every time the thumbnail image data output/display state is validated. Furthermore, such state transition between the thumbnail image data output/display state and the picture recording/reproducing state may also take place frequently due to erroneous manipulation of the user.

Such being the circumstances, according to the teachings of the invention incarnated in the illustrated embodiment, it is also proposed that the thumbnail-image-dedicated storage area 304 is secured on the memory 105 for holding the thumbnail image data of an amount corresponding to the number of the display fields (e.g. twelve fields) for the thumbnail images being currently displayed.

Thus, upon transition from the state in which the thumbnail image data is being displayed to the picture recording or reproducing mode, those of the thumbnail image data held in the shared storage area 303 which are currently displayed are copied onto the thumbnail-image-dedicated storage area 304 under the control of the CPU 103. After completion of this copying process, the shared storage area 303 is used as the buffer for storing the picture data to be recorded or reproduced.

On the other hand, when the state transition is made again to the state for displaying the thumbnail images from the state for picture recording or reproduction, the CPU 103 checks whether the thumbnail image data concerned is held in the thumbnail-image-dedicated storage area 304 before loading the concerned thumbnail image data in the shared storage area 303 of the memory 105 from the thumbnail image data recording subarea 204 shown in FIG. 2.

When the thumbnail image data concerned is saved in the thumbnail-image-dedicated storage area 304, the thumbnail image data concerned is read out from this area 304 to be outputted to the monitor 104 for display without carrying out the operation for reading the thumbnail image data from the recording medium 106 and writing the data in the shared storage area 303.

With the arrangement described above, there arises no necessity of making access to the recording medium 106 for reading the thumbnail image data to be displayed so long as the thumbnail image data for display is held in the thumbnail-image-dedicated storage area 304, which means that the outputting of the thumbnail image data to the monitor 104 can be carried out at a high speed. Thus, the nimbleness or agility of manipulation for changing over the thumbnail image displaying state to the picture recording or reproducing mode or vice versa can remarkably be enhanced. As will be apparent from the foregoing, according to the teachings of the present invention, the thumbnail image can be displayed on the monitor 104 at a significantly high speed owing to the arrangement that the thumbnail-image-dedicated storage area 304 is provided in addition to the shared storage area. At this juncture, it should also be mentioned that by making use of the attribute data storage area 302 solely or in combination with the shared storage area 303, a high-speed display of the attribute data such as those mentioned hereinbefore can equally be accomplished.

Next, referring to FIG. 4, description will be made in detail of the structure of the storage area 202 shown in FIG. 2. The storage area 202 is comprised of the attribute data recording subarea 203 and the thumbnail image recording subarea 204. As can be seen in FIG. 4, within the storage area 202, the attribute data and the thumbnail image data are arrayed in this order, starting from the attribute data. In the attribute data recording subarea 203, there can be recorded a plurality of attribute data. In this conjunction, it is to be noted that one attribute data corresponds to one sequence of the picture data. Similarly, a plurality of the thumbnail image data can be recorded in the thumbnail image recording subarea 204, wherein one thumbnail image data corresponds to one attribute data.

More specifically, every time the picture recording or image transcription is performed, the CPU 103 generates one corresponding attribute data and one corresponding thumbnail image data. The overall size of the attribute data recording subarea 203 is fixed to a size which is capable of storing the attribute data in an amount which corresponds to a maximum number of pictures (e.g. 999) which can be transcribed or recorded by the apparatus and thus remains constant independently from the number of the pictures as recorded. In general, the size or amount of one attribute data is in a range of one several-tenth to one-several-hundredth of one thumbnail image data.

By fixing the size of the attribute data recording subarea 203 destined for storing the attribute data of a relatively small amount in this manner, such troublesome processing of large overhead which will be involved, for example, for shifting the thumbnail image data recording subarea 204 as a whole can be avoided even in the case where the thumbnail image data is added or deleted. Thus, the contents of the storage area 202 can be altered or modified easily and speedily.

On the other hand, the size of the thumbnail image data recording subarea 204 is made to be variable in dependence on the number of the thumbnail image data as stored.

As mentioned above, by making the size of the thumbnail image data recording subarea 204 variable in dependence on the number of the thumbnail image data stored in this subarea 204 in view of the fact that the size of one thumbnail image data is significantly large when compared with that of one attribute data, the overall size of the storage area 202 can be diminished to a necessary minimum, which in turn means that management of the storage area 202 can be facilitated.

Next, description will be directed to an arrangement for realizing prevention of fragmentation of the storage area 202 secured on the random access recording medium 106 while allowing high-speed access. When the picture recording (or image transcription) is repeated, there are recorded in the storage area 202 shown in FIG. 4 the attribute data and the thumbnail image data each in an amount corresponding to the number of times the picture pick-up/recording operation is performed.

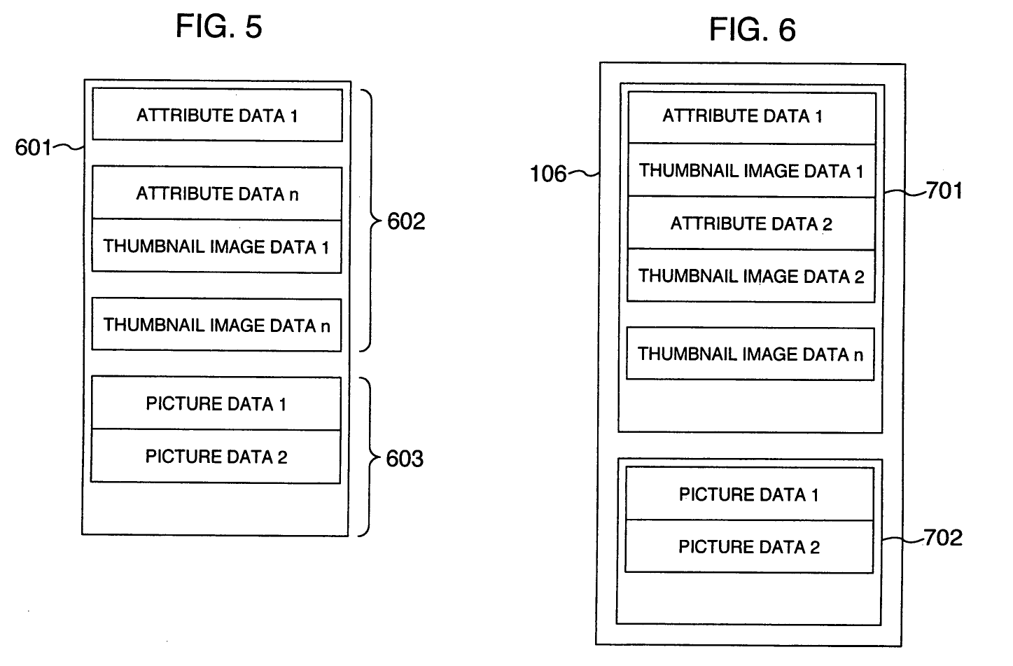

Under the circumstances, it is preferred that a dummy storage area 601 of a size which can accommodate a maximum sum of the sizes of a recording area 602 for the attribute data and the thumbnail image data and a picture data recording area 603 be secured on the random access recording medium 106, as is illustrated in FIG. 5. In this figure, the areas for the attribute data, the thumbnail image data and the picture data, respectively, are shown as being arrayed in this order. In practice, however, the area 602 is disposed along the innermost periphery of the recording medium 106 while the area 603 is so allocated as to extend from the area 603 toward the outermost periphery.

With the arrangement described above, the attribute data/thumbnail image data recording area 602 can be protected against being fragmented by the picture data. Additionally, the attribute data can be prevented from increasing excessively on the recording medium 106.

As a modification, an area 701 which is not destined for recording the picture data may physically be secured on the random access recording medium 106 for recording therein the attribute data and the thumbnail image data, as is shown in FIG. 6. In this case, the picture data recording area 702 is secured on the recording medium 106 outside of the attribute/thumbnail image data recording area 701.

Many modifications and variations of the present invention are possible in the light of the above techniques. It is therefore to be understood that within the scope of the appended claims, the invention may be practiced otherwise than as specifically described.

1. A data recording medium method of recording a plural pieces of picture data on an optical disk, comprising the steps of:
consecutively recording pieces of attribute data indicative of attributes of the plural pieces of picture data, respectively, on previously reserved areas; and
consecutively recording thumbnail data indicative of a group of the plural pieces of picture data on subsequent areas from the recording areas for the attribute data.

2. The data recording method according to claim 1, wherein the previously reserved areas are physically consecutive areas.

3. The data recording method according to claim 1, wherein each capacity of the previously reserved areas is constant regardless of amount of the attribute data.

4. The data recording method according to claim 1, wherein the area used for recording the thumbnail data is an area subsequent the previously reserved area.

5. A data reproduction method for reproducing picture data from an optical disk, comprising the steps of:
storing thumbnail data being displayed on a display in a memory when changing from a displaying state indicative of displaying a thumbnail picture indicating a typified picture of the picture data to a reproducing state of the picture data; and
displaying a thumbnail picture by using the thumbnail data being stored in the memory when changing from the reproducing state of the picture data to the displaying state indicative of displaying the thumbnail picture.

6. The data reproduction method according to claim 5, wherein
the thumbnail data is stored in a predetermined area of the memory in the displaying state of the thumbnail picture;
transferring the thumbnail data being displayed on the display to other areas of the memory, among the thumbnail data being recorded on the predetermined areas of the memory, when changing from the displaying state of displaying the thumbnail picture to the reproducing state; and
displaying the thumbnail picture by using the thumbnail data being stored in other areas of the memory when changing the reproducing state of the picture data to the displaying state of the thumbnail picture.

7. The data reproduction method according to claim 6, wherein the predetermined area of the memory is used for a buffer for the picture data when reproducing the picture data, and used for a buffer for the thumbnail data when displaying the thumbnail picture.

8. A data reproduction method of reproducing picture data from an optical disk, comprising the steps of:
previously recording thumbnail data indicating a typified picture of the picture data on the optical disk at least;
providing at least a displaying state of a thumbnail picture and a reproducing state of the picture data, in the reproduction;
once recording the thumbnail data being recorded on the optical disk on a memory and displaying the thumbnail picture by using the thumbnail data being stored in the memory, in the display of the thumbnail picture; and
maintaining the thumbnail data in the memory until changing over a state of reproducing the picture data.
